(19) United States
(12) Patent Application Publication
(10) Pub. No.: US 2026/0284965 A1
(43) Pub. Date: Sep. 24, 2026

(54) VOLUMETRIC ADDITIVE MANUFACTURING USING CYCLOOLEFIN RESINS

(71) Applicant: The Regents of the University of California, Oakland, CA (US)

(72) Inventors: Brett A. HELMS, Oakland, CA (US); Hayden K. TAYLOR, Oakland, CA (US); Kristin A. CEDER-PERSSON, Oakland, CA (US); Jay D. KEASLING, Oakland, CA (US); Zhen XU, Oakland, CA (US); Zi WANG, Oakland, CA (US); Mason WITKO, Oakland, CA (US); Nour AKIKI, Oakland, CA (US); Maxwell VENETOS, Oakland, CA (US); Hongqian ZHENG, Oakland, CA (US); Sarah KLASS, Oakland, CA (US)

(73) Assignee: The Regents of the University of California, Oakland, CA (US)

(21) Appl. No.: 19/573,335

(22) Filed: Mar. 20, 2026

Related U.S. Application Data
(60) Provisional application No. 63/775,794, filed on Mar. 21, 2025.

(51) Int. Cl. B29C 64/124; B29B 17/02; B29K 23/00; B29K 105/00; B33Y 40/00; B33Y 70/10

(52) U.S. Cl. CPC B29C 64/124; B29B 17/02; B33Y 40/00; B33Y 70/10; B29B 2017/0293; B29K 2023/38; B29K 2105/0014

(57) ABSTRACT

Compositions of cycloolefin resins including dicyclopentadiene (DCPD) and volumetric additive manufacturing methods using the same. A composition of cycloolefin can include: a mixture of dicyclopentadiene (DCPD) and ethylidene norbornene (ENB); and a catalyst solution including: (1,3-dimesitylimidazolidin-2-ylidene)dichloro(2-((2-ethoxy-2-oxoethylidene)amino)benzylidene)ruthenium(II) (HeatMet); benzil; ethyl 4-(dimethylamino)benzoate; and tetrahydrofuran (THF), wherein the composition when used in computed axial lithography (CAL) printing achieves a 1/e² transmission requirement.

### CROSS-REFERENCE

This application claims priority to 63/775,794, filed Mar. 21, 2025, the contents of which are incorporated herein in their entirety.

### GOVERNMENT LICENSE RIGHTS

This invention was made with government support under DE-AC02-05CH11231 awarded by the Department of Energy, and under 2018784 and 2036849 awarded by the National Science Foundation. The government has certain rights in the invention.

### BACKGROUND

### 1. Technical Field

The present disclosure relates to compositions of cycloolefin resins including dicyclopentadiene (DCPD) and volumetric additive manufacturing using the same.

### 2. Introduction

During the last decade, volumetric additive manufacturing (VAM) emerged as a novel method of 3D printing freeform geometries. VAM includes selectively curing target regions within a photosensitive resin 3D volume, unlike layer-by-layer techniques. This method offers the benefit of eliminating the need for support structures, which may be needed in traditional additive manufacturing (AM) processes. Up to two orders of magnitude faster printing is achieved with VAM, as compared to state-of-the-art (SoA) methods such as digital light processing (DLP) and stereolithography apparatus (SLA). Specifically, computed axial lithography (CAL) is a type of VAM where 3D objects are created all at once, within seconds, using UV light. It is a digital light manufacturing (DLM) process where every single point within the target geometry is created simultaneously. Using this layerless approach, printing highly viscous materials with desirable mechanical properties is possible. The combination of the layerless process with the elimination of the need for support structures results in CAL's capability to fabricate smooth and soft objects, hardly achievable with traditional AM techniques. Furthermore, CAL entails printing inside of a sealed resin container, which makes it a completely human intact 3D printing process, especially beneficial for bioprinting applications and reducing workers' chemical exposure. In addition, the CAL process can be fully automated due to the simplicity of its configuration, making it a widely accessible technology to non-specialist users and the wider public. Up to date, mostly acrylate and methacrylate chemistries have been used with CAL, in addition to epoxy resins, hydrogels and thiol-enes. So far, no effort has been made to print recyclable thermosets with CAL. Unlike thermoplastics used with Fused Deposition Modeling (FDM), for example, thermosets are not thermally recyclable, making it more challenging for DLM processes to achieve circular economy. However, thermosets exhibit higher thermal resistance and tensile strength than thermoplastics, making them more desirable for structural components.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are compositions and methods which provide a technical solution to the technical problem described. A composition configured according to the concepts disclosed herein can include: a mixture of dicyclopentadiene (DCPD) and ethylidene norbornene (ENB); and a catalyst solution including: (1,3-dimesitylimidazolidin-2-ylidene)dichloro(2-((2-ethoxy-2-oxoethylidene)amino)benzylidene)ruthenium(II) (HeatMet); benzil; ethyl 4-(dimethylamino)benzoate; and tetrahydrofuran (THF), wherein the composition when used in computed axial lithography (CAL) printing achieves a 1/e² transmission requirement.

A method for performing the concepts disclosed herein can include: mixing dicyclopentadiene (DCPD) and ethylidene norbornene (ENB) to provide a mixture of DCPD: ENB; preparing a catalyst solution by mixing (1,3-dimesitylimidazolidin-2-ylidene)dichloro(2-((2-ethoxy-2-oxoethylidene)amino)benzylidene)ruthenium(II) (HeatMet), benzil, and ethyl 4-(dimethylamino)benzoate to provide a catalyst mixture, and adding tetrahydrofuran (THF) to form the catalyst solution; and adding a measured quantity of the catalyst solution to a measured quantity of the DCPD: ENB mixture to provide the composition of cycloolefin resin including DCPD.

A method for performing the concepts disclosed herein can include: preheating a vial containing the composition of cycloolefin resin; cooling down the vial containing the composition of cycloolefin resin; placing the vial on a sample holder; rotating the vial; projecting synchronized patterns of light onto the vial to cure a portion of the composition of cycloolefin resin to form the object; and removing a portion of the composition of cycloolefin resin that is not cured to extract the object.

A method for performing the concepts disclosed herein can include: placing the cured material on a flask with a stir bar; adding a quantity of toluene containing a catalyst to obtain a solution; sparging the solution with nitrogen gas; heating the flask to 90° C. for about 12 hours; adding ethyl vinyl ether to the flask to quench the catalyst; adding 100 mg Quadrapure TU macroporous particle to the flask to further remove the catalyst and color to obtain a mixture; filtering the mixture from cold methanol to afford a white solid as the recyclate; and drying the recyclate by using vacuum filtration to recover dry recyclate.

A method for performing the concepts disclosed herein can include: identifying cycloolefin amine rings occurring naturally; calculating ring strain energies (RSEs) of the cycloolefin amine rings by calculating a change in enthalpy of a ring closing metathesis reaction to provide target cycloolefin amine rings; identifying target cycloolefin rings with ring strain energies similar to energies (±0.6 kJ/mol) of cyclopentene; modeling interactions between a ruthenium(II) alkylidene catalyst and different structural rings in the target cycloolefin rings containing nitrogen; analyzing interactions between a nitrogen atom in the target cycloolefin rings containing nitrogen rings and the ruthenium(II) alkylidene catalyst among a plurality of nitrogen containing rings using energy decomposition analysis; and determining which ring in the plurality of nitrogen containing rings that is less likely to associate with the ruthenium(II) alkylidene catalyst.

### BRIEF DESCRIPTION OF THE DRAWINGS

FIG. 1 illustrates an example system embodiment;

FIG. 2 illustrates an example graph of storage and loss moduli during UV light-initiated curing;

FIG. 3 illustrates an example UV light exposure material response for CAL printing;

FIG. 4 illustrates an example recycling process for DCPD thermoset materials using ruthenium-catalyzed depolymerization;

FIG. 5 illustrates an example resin-to-resin circularity diagram for DCPD copolymers;

FIG. 6 illustrates an example diagram of comonomer systems for DCPD-based copolymers and recyclates;

FIG. 7 illustrates an example computational workflow for screening cycloolefin amine monomers;

FIG. 8 illustrates an example computational analysis of ruthenium-nitrogen interactions and bio-based linkers;

FIG. 9 illustrates an example thermal and photo-polymerization of bio-based crosslinked polymers;

FIG. 10 illustrates an example screening of cycloolefin amine structures organized by ring size;

FIG. 11 illustrates a first example method embodiment;

FIG. 12 illustrates a second example method embodiment;

FIG. 13 illustrates a third example method embodiment;

FIG. 14 illustrates a fourth example method embodiment; and

FIG. 15 illustrates a fifth example method embodiment.

### DETAILED DESCRIPTION

Various embodiments of the disclosure are described in detail below. While specific implementations are described, this is done for illustration purposes only. Other components and configurations may be used without parting from the spirit and scope of the disclosure.

Volumetric additive manufacturing represents an approach to three-dimensional (3D) printing where an entire object may be formed simultaneously within a volume of photocurable material, rather than through layer-by-layer deposition. Computed axial lithography (CAL) is a volumetric printing technique that projects patterned light from multiple angles into a rotating container of photocurable resin, where the superposition of light doses causes selective curing to form a 3D object. The present disclosure relates to compositions of cycloolefin resin including dicyclopentadiene (DCPD) that may be used in CAL printing applications. These compositions may include a mixture of DCPD and ethylidene norbornene (ENB), along with a catalyst solution containing a ruthenium-based catalyst, photoinitiator components, and a solvent. The compositions may be formulated to achieve optical transmission characteristics suitable for volumetric printing, where light penetrates through the resin volume to enable simultaneous curing throughout the material. DCPD-based thermosets produced using these compositions may exhibit desirable mechanical properties including high strength and thermal stability. A feature of the disclosed compositions is that cured materials may be recycled through catalytic depolymerization processes. The recyclate obtained from depolymerization may be reincorporated into fresh resin batches without substantial loss of material properties, enabling a circular material lifecycle for 3D printed thermoset objects.

The disclosed methods may include preparing the cycloolefin resin compositions, performing CAL printing to form objects, and recycling cured materials to recover reusable polymer. The preparation method may involve mixing DCPD and ENB in specified ratios, preparing a catalyst solution with appropriate concentrations of ruthenium catalyst and photoinitiator components, and combining these to form the printable resin. The CAL printing method may involve preheating and cooling the resin composition, rotating the resin container, and projecting synchronized light patterns to selectively cure portions of the resin. The recycling method may involve dissolving cured material in a solvent containing a metathesis catalyst, heating to depolymerize the crosslinked network, quenching the catalyst, and recovering the recyclate through filtration and drying. The recovered recyclate may be added to fresh resin batches at concentrations up to 30 weight percent.

The disclosed compositions and methods address a gap in volumetric additive manufacturing by providing recyclable thermoset materials compatible with CAL printing. Prior CAL systems have relied on acrylate-based photopolymers that lack recyclability and may not achieve the mechanical performance of thermoset materials. The combination of DCPD-based ring-opening metathesis polymerization chemistry with CAL printing enables production of high-performance thermoset objects through rapid volumetric curing, while the reversible nature of the metathesis crosslinks permits chemical recycling of printed parts. This approach may provide both manufacturing speed advantages and material sustainability benefits not previously available in volumetric printing systems.

Computed axial lithography (CAL) is a volumetric additive manufacturing technique that forms three-dimensional objects by projecting two-dimensional images into a rotating volume of photocurable material from multiple angles. As the container rotates, a sequence of computed projection patterns is delivered such that the cumulative light dose within the material volume exceeds a curing threshold in regions corresponding to the target geometry. Regions receiving insufficient cumulative dose remain uncured and may be removed after printing. This approach enables rapid fabrication of complete objects without the layer-by-layer build process used in conventional 3D printing methods. The projection patterns may be computed using tomographic reconstruction principles, where the desired three-dimensional dose distribution is decomposed into a set of angular projections.

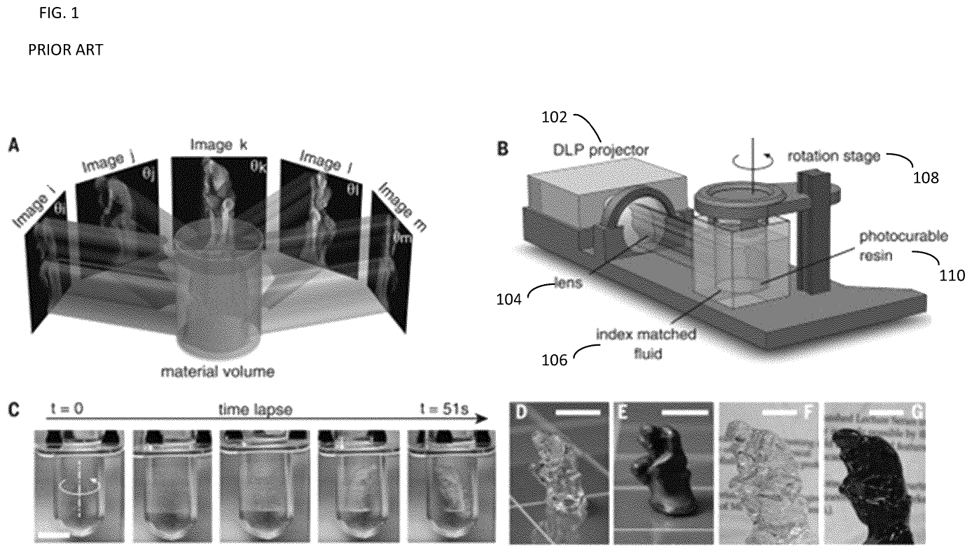

Referring to FIG. 1, a CAL system may include a DLP projector 102 that generates patterned light for projection onto a photocurable resin 110. A lens 104 may be positioned between the DLP projector 102 and a resin container to focus and direct the projected light patterns. The photocurable resin 110 may be contained within a cylindrical vessel submerged in an index matched fluid 106, which reduces optical distortion caused by the curved surface of the resin container and enables accurate light delivery to the photocurable resin 110. A rotation stage 108 may support and rotate the container holding the photocurable resin 110, allowing the projected patterns to be delivered from multiple angles as the container rotates. The coordinated operation of the DLP projector 102 projecting synchronized patterns while the rotation stage 108 rotates the photocurable resin 110 enables volumetric curing of target geometries. As described previously, the composition when used in computed axial lithography (CAL) printing may achieve a 1/e² transmission requirement, which corresponds to light penetrating through the resin volume with sufficient intensity to enable curing throughout the material.

UV light-initiated curing in photopolymer systems involves exposing a photocurable material to ultraviolet radiation, which triggers chemical reactions that transform the material from a liquid or gel state into a solid crosslinked network. When UV light interacts with photoinitiator molecules in the resin, reactive species are generated that initiate polymerization or crosslinking reactions. The curing process does not occur instantaneously upon light exposure; rather, the material undergoes distinct phases as the crosslinking reactions progress. Understanding these phases and the timing of transitions between them is relevant for controlling print quality in volumetric additive manufacturing applications, where the relationship between light dose and material solidification determines the fidelity of printed objects.

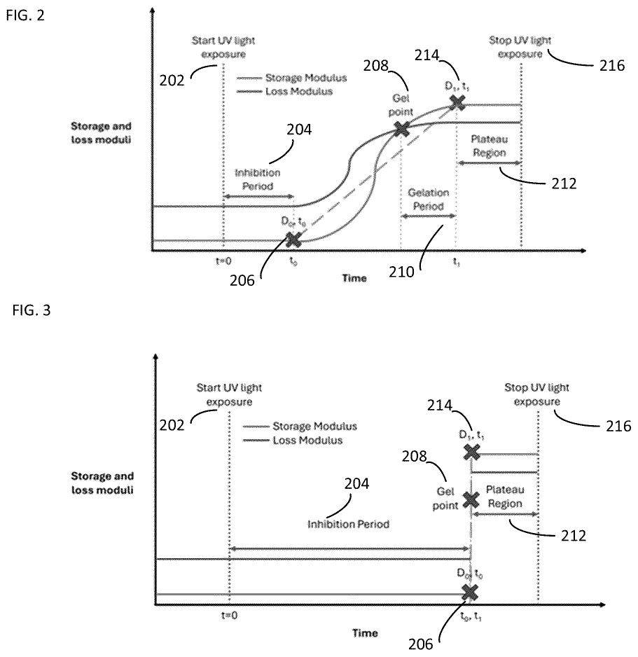

Referring to FIG. 2, a graph illustrates the relationship between storage and loss moduli as a function of time during a UV light-initiated curing process. The process begins when a start UV light exposure 202 occurs, indicated by a vertical dashed line at t=0. Following the start UV light exposure 202, an inhibition period 204 extends from t=0 to an end of inhibition period 206, marked as D₀, t₀, where the storage modulus begins to increase. During the inhibition period 204, oxygen or other inhibiting species consume reactive radicals before polymerization can proceed. A gel point 208 is identified where the storage modulus and loss modulus curves intersect, occurring during a gelation period 210 that spans from the end of inhibition period 206 to an end of gelation period 214, marked as D₁, t₁. Following the gelation period 210, a plateau region 212 is reached where both moduli stabilize at relatively constant values. The process concludes when a stop UV light exposure 216 occurs.

With continued reference to FIG. 3, material contrast (MC) may be defined using a dimensionless gamma value: γ=(log 10(D1/D0))−1=(log 10(t1/t0))−1, where γ is the material contrast, D₀ and D₁ represent the conversion at the conclusion of the inhibition period 204 and the start of the plateau region 212, respectively, and t₀ and t₁ represent the time at which D₀ and D₁ are reached, respectively. D and t may be assumed to be proportional. The MC represents the slope of the conversion curve in the region bounded by the end of inhibition period 206 and the end of gelation period 214. At a gamma value of 1 or above, acceptable part fidelity may be expected. High γ values indicate highly non-linear UV exposure material response, which infinitesimally converges to a step function as shown in FIG. 3.

A composition of cycloolefin resin including dicyclopentadiene (DCPD) may be formulated for use in computed axial lithography printing applications. The composition may include a mixture of dicyclopentadiene (DCPD) and ethylidene norbornene (ENB). DCPD serves as a primary monomer that undergoes ring-opening metathesis polymerization to form crosslinked thermoset networks. ENB functions as a comonomer that copolymerizes with DCPD and may influence the reactivity and properties of the resulting polymer. The combination of DCPD and ENB may provide a resin system with suitable polymerization kinetics for volumetric printing processes.

The composition may include a catalyst solution containing several components. The catalyst solution may include (1,3-dimesitylimidazolidin-2-ylidene)dichloro(2-((2-ethoxy-2-oxoethylidene)amino)benzylidene)ruthenium(II), which is referred to as HeatMet. HeatMet is a latent ruthenium-based metathesis catalyst that may be activated by light or heat to initiate ring-opening metathesis polymerization of the cycloolefin monomers. The catalyst solution may also include benzil, which functions as a photosensitizer that absorbs light and transfers energy to activate the HeatMet catalyst. The catalyst solution may further include ethyl 4-(dimethylamino)benzoate, which may function as a co-initiator or electron donor in the photoactivation process. The catalyst solution may include tetrahydrofuran (THF) as a solvent to dissolve and disperse the catalyst and photoinitiator components uniformly within the resin mixture.

A quantity ratio of DCPD to ENB in the mixture may be about 95:5 weight percent. This ratio provides a resin composition where DCPD constitutes the majority component while ENB is present as a minor comonomer. The 95:5 weight percent ratio may balance the crosslinking density provided by DCPD with the reactivity modification provided by ENB.

A quantity of HeatMet in the composition may be about 10 mg or about 15.0 μmol. A concentration ratio of HeatMet: DCPD may be 10 ppm to 40 ppm. In some cases, a catalyst solution mixture concentration of about 32.5 ppm may be used. The concentration of catalyst affects both the polymerization rate and the optical properties of the resin. Lower catalyst concentrations may result in slower curing but greater light penetration depth, while higher catalyst concentrations may accelerate curing but reduce light penetration.

The composition when used in computed axial lithography printing may achieve a 1/e² transmission requirement. The 1/e² transmission requirement refers to the optical condition where light intensity decreases to approximately 13.5% of the incident intensity after passing through the resin volume. This transmission level corresponds to the depth at which sufficient light energy remains to contribute to the cumulative dose distribution within the material. Achieving the 1/e² transmission requirement across the diameter of the resin container enables light projected from multiple angles to penetrate through the entire volume and superimpose to create the three-dimensional dose distribution for selective curing. The catalyst concentration and resin formulation may be adjusted to achieve this transmission characteristic for a given container diameter, where larger diameter containers may use lower catalyst concentrations to maintain adequate light penetration depth.

A method of making a composition of cycloolefin resin including dicyclopentadiene (DCPD) may involve several preparation steps. The method may include mixing dicyclopentadiene (DCPD) and ethylidene norbornene (ENB) to provide a mixture of DCPD: ENB. As described previously, a quantity ratio of DCPD to ENB in the DCPD: ENB mixture may be about 95:5 weight percent. The DCPD and ENB may be combined in a container and mixed until a homogeneous mixture is obtained.

The method may include preparing a catalyst solution by mixing (1,3-dimesitylimidazolidin-2-ylidene)dichloro(2-((2-ethoxy-2-oxoethylidene)amino)benzylidene)ruthenium(II) (HeatMet), benzil, and ethyl 4-(dimethylamino)benzoate to provide a catalyst mixture. Tetrahydrofuran (THF) may be added to form the catalyst solution. The THF serves as a solvent that dissolves the HeatMet catalyst, benzil photosensitizer, and ethyl 4-(dimethylamino)benzoate co-initiator to form a homogeneous catalyst solution. The components may be combined and stirred until dissolution is complete.

The method may include adding a measured quantity of the catalyst solution to a measured quantity of the DCPD:ENB mixture to provide the composition of cycloolefin resin including DCPD. The measured quantities may be selected based on the desired catalyst concentration in the final composition and the optical properties required for the printing application.

The composition of cycloolefin resin including DCPD may be provided in a vial. The vial may serve as the container in which the resin is held during computed axial lithography printing. An amount of the catalyst solution in the composition of cycloolefin resin including DCPD may depend on a width size or a diameter size of the vial. The method may include selecting a vial having a width or a diameter such that light penetrates through the width or diameter of the vial.

The relationship between vial dimensions and catalyst concentration may be understood as follows: the larger the width or diameter of the vial, the longer a depth of penetration of light is needed. A lower amount of the catalyst solution may be used for a vial having a larger width or diameter, and a higher amount of the catalyst solution may be used for a vial having a smaller width or diameter. This inverse relationship between vial diameter and catalyst concentration enables the resin to maintain appropriate optical transmission characteristics across different container sizes.

The width or the diameter of the vial may be from 5 mm to 50 mm. This range of vial dimensions may accommodate various object sizes while maintaining compatibility with computed axial lithography printing systems. A transmittance of light through the width or diameter of the vial may be about 13.5%, the light having a wavelength in an ultraviolet spectrum range or a visible spectrum range. The 13.5% transmittance corresponds to the 1/e² transmission level described previously, which enables sufficient light penetration for volumetric curing while maintaining adequate dose contrast between cured and uncured regions.

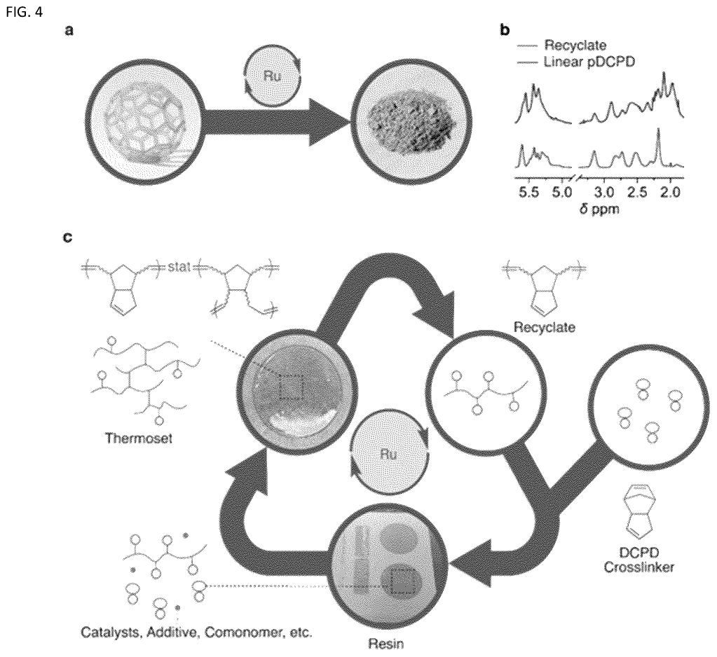

Referring to FIG. 4, a recycling process for dicyclopentadiene (DCPD) thermoset materials using ruthenium-catalyzed depolymerization is illustrated. Panel (a) depicts the transformation of a crosslinked thermoset structure into a powder recyclate through treatment with a ruthenium catalyst. Panel (b) shows proton nuclear magnetic resonance (NMR) spectra comparing the recyclate with linear pDCPD, demonstrating structural similarity between the recycled material and linear polymer. Panel (c) illustrates a circular recycling scheme for DCPD-based thermosets, where treatment with a ruthenium catalyst breaks down the crosslinked network to produce a recyclate containing linear polymer chains, which may then be combined with fresh DCPD crosslinker to regenerate a thermoset material.

A method of recycling a cured material including dicyclopentadiene (DCPD) may involve several processing steps. The cured material may comprise a copolymer of DCPD and ethylidene norbornene (ENB). In some cases, the cured material may comprise a copolymer of DCPD and cyclooctene (COE). The method may include placing the cured material on a flask with a stir bar. The method may include adding a quantity of toluene containing a catalyst to obtain a solution. A concentration of the cured material in the toluene may be about 50 mM. The catalyst may comprise a second generation Hoveyda-Grubbs ruthenium(II) alkylidene catalyst. The catalyst may be present at about 0.2 mol %.

The method may include sparging the solution with nitrogen gas to remove oxygen and create an inert atmosphere for the depolymerization reaction. The method may include heating the flask to 90° C. for about 12 hours to drive the metathesis-mediated depolymerization of the crosslinked network.

Following the heating step, the method may include adding ethyl vinyl ether to the flask to quench the catalyst. The ethyl vinyl ether reacts with the ruthenium catalyst to terminate catalytic activity. The method may include adding 100 mg Quadrapure TU macroporous particle to the flask to further remove the catalyst and color to obtain a mixture. The Quadrapure TU macroporous particles scavenge residual ruthenium species and colored impurities from the solution.

The method may include filtering the mixture from cold methanol to afford a white solid as the recyclate. The cold methanol precipitation separates the depolymerized polymer chains from the solvent and remaining impurities. The method may include drying the recyclate by using vacuum filtration to recover dry recyclate. A yield of the dry recyclate may be about 84%.

The method may further include storing the dry recyclate under nitrogen to prevent oxidation. Storage under inert atmosphere preserves the chemical integrity of the recyclate for subsequent reuse. The method may further include adding the dry recyclate up to 30% in weight to a fresh batch of DCPD: ENB without loss in material properties upon polymerization. This reincorporation of recyclate into fresh resin batches enables a circular material lifecycle where printed thermoset objects may be depolymerized and the recovered polymer chains may be used to produce new objects with comparable mechanical performance.

Referring to FIG. 5, a resin-to-resin circularity diagram illustrates a recycling cycle for dicyclopentadiene-based thermoset materials. A DCPD 502 serves as a starting monomer that forms a pristine or recycled resins 504. The pristine or recycled resins 504 undergo polymerization facilitated by a ruthenium catalyst 514 to produce a pristine or recycled thermosets 506, which are crosslinked polymer structures. The pristine or recycled thermosets 506 undergo a decrosslink 508 process to generate a recyclate 510, depicted as a linear polymer chain with pendant cyclopentene groups. The recyclate 510 is then combined with fresh DCPD through a mix with DCPD in×wt % 512 step, which feeds back into the pristine or recycled resins 504 to complete the recycling loop. The ruthenium catalyst 514 is positioned centrally in the diagram, indicating the role of the ruthenium catalyst 514 in facilitating both polymerization and depolymerization reactions within the cycle.

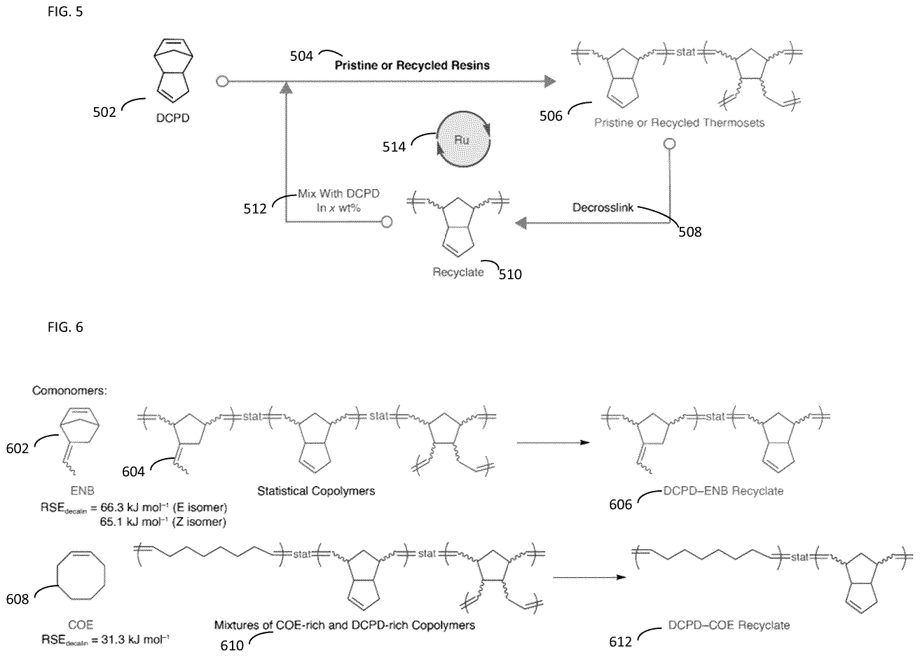

Referring to FIG. 6, two comonomer systems for DCPD-based copolymers and corresponding recyclates are illustrated. An ENB 602, shown as ethylidene norbornene, serves as a comonomer that forms a statistical copolymers 604 with DCPD units distributed randomly along the polymer backbone. The ENB 602 has ring strain energy values of 66.3 kJ mol⁻¹ for the E isomer and 65.1 kJ mol⁻¹ for the Z isomer, measured in decalin. The statistical copolymers 604 undergo depolymerization to produce a DCPD-ENB recyclate 606, which retains the statistical distribution of monomer units from the original copolymer structure.

The ring strain energy of a cyclic olefin monomer influences the thermodynamics and kinetics of ring-opening metathesis polymerization. Monomers with higher ring strain energies may exhibit greater driving force for ring-opening reactions, which affects copolymerization behavior when two monomers with different ring strain energies are combined. The ENB 602 has ring strain energy values comparable to DCPD, which enables formation of the statistical copolymers 604 where both monomer types are incorporated throughout the polymer chain in a random distribution. This statistical incorporation results from similar reactivities of the two monomers toward the ruthenium catalyst 514 during polymerization.

A COE 608, shown as cyclooctene, has a ring strain energy of 31.3 kJ mol⁻¹ in decalin. The COE 608 forms a mixtures of COE-rich and DCPD-rich copolymers 610 rather than true statistical copolymers due to the difference in ring strain energies between the monomers. The lower ring strain energy of the COE 608 compared to DCPD results in different polymerization kinetics, leading to compositional heterogeneity in the resulting copolymer mixture. The mixtures of COE-rich and DCPD-rich copolymers 610 undergo depolymerization to produce a DCPD-COE recyclate 612.

The difference in copolymer structure between the ENB 602 system and the COE 608 system has implications for the properties of both the thermoset materials and the recyclates. The statistical copolymers 604 formed with the ENB 602 may provide more uniform crosslink distribution throughout the network, while the mixtures of COE-rich and DCPD-rich copolymers 610 formed with the COE 608 may exhibit phase-separated or gradient structures. Upon depolymerization, the DCPD-ENB recyclate 606 may contain polymer chains with statistically distributed monomer units, while the DCPD-COE recyclate 612 may contain a mixture of chains with varying compositions.

The ring strain energy values provide guidance for selecting comonomers for DCPD-based resin systems. Comonomers with ring strain energies similar to DCPD, such as the ENB 602, may form statistical copolymers with uniform properties. Comonomers with substantially different ring strain energies, such as the COE 608, may form copolymer mixtures with compositional heterogeneity. Both comonomer systems may be recycled through the decrosslink 508 process using the ruthenium catalyst 514, and the resulting recyclates may be reincorporated into fresh resin batches through the mix with DCPD in x wt% 512 step to complete the circularity cycle.

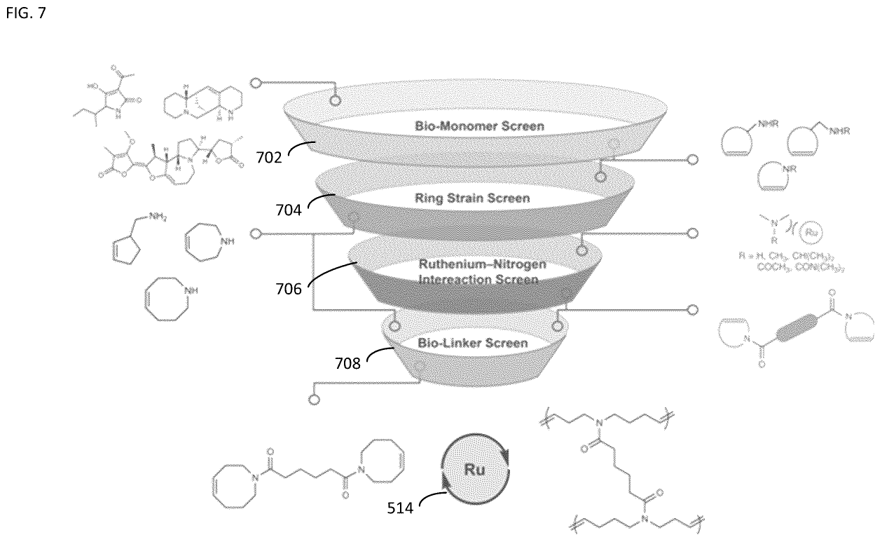

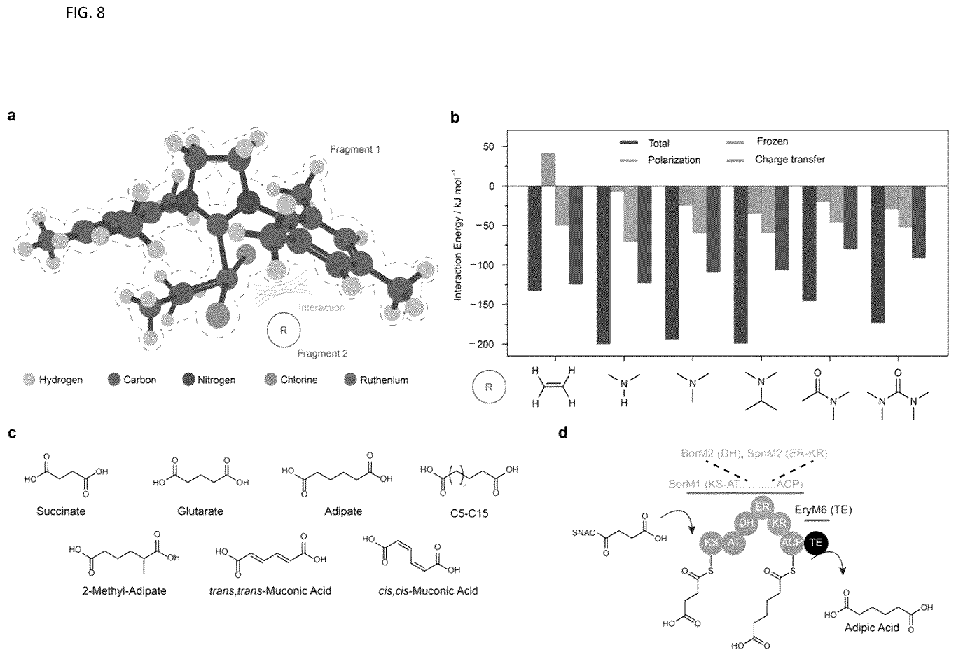

Referring to FIG. 7, a computational workflow for screening and selecting cycloolefin amine monomers compatible with the ruthenium catalyst 514 is illustrated. The screening process is represented as a funnel-shaped workflow comprising four sequential screening stages. A bio-monomer screen 702 forms the uppermost and widest stage of the funnel, receiving input molecules including various bio-based cycloolefin structures containing nitrogen atoms. A ring strain screen 704 is positioned below the bio-monomer screen 702 and filters candidates based on ring strain energy calculations. A ruthenium-nitrogen interaction screen 706 is located below the ring strain screen 704 and evaluates interactions between nitrogen-containing rings and ruthenium catalysts. A bio-linker screen 708 forms the narrowest and bottommost stage of the funnel. The output of the screening process leads to the ruthenium catalyst 514, along with polymer chain structures representing resulting polymerization products suitable for ring-opening metathesis polymerization.

A method of selecting a cycloolefin amine monomer from bio-based cycloolefin amines may involve several computational and analytical steps. The method may include identifying cycloolefin amine rings occurring naturally. Natural sources may provide cycloolefin amine structures that serve as starting points for the bio-monomer screen 702. The method may include calculating ring strain energies (RSEs) of the cycloolefin amine rings by calculating a change in enthalpy of a ring closing metathesis reaction to provide target cycloolefin amine rings. The ring strain energy calculation quantifies the thermodynamic driving force for ring-opening reactions, which affects polymerization behavior when the monomer is combined with the ruthenium catalyst 514.

The method may include identifying target cycloolefin rings with ring strain energies similar to energies of cyclopentene, within a tolerance of ±0.6 kJ/mol. Cyclopentene serves as a reference compound because the ring strain energy of cyclopentene is comparable to that of the DCPD 502, and monomers with similar ring strain energies may exhibit compatible polymerization kinetics when copolymerized. The ring strain screen 704 filters candidate monomers based on this ring strain energy criterion, retaining monomers that fall within the specified tolerance range.

The method may include modeling interactions between a ruthenium(II) alkylidene catalyst and different structural rings in the target cycloolefin rings containing nitrogen. The ruthenium-nitrogen interaction screen 706 evaluates how nitrogen atoms in the candidate monomers interact with the ruthenium center of the catalyst. Nitrogen-containing functional groups may coordinate to ruthenium metal centers, which may affect catalyst activity and polymerization behavior.

The method may include analyzing interactions between a nitrogen atom in the target cycloolefin rings containing nitrogen and the ruthenium(II) alkylidene catalyst among a plurality of nitrogen containing rings using energy decomposition analysis. Energy decomposition analysis partitions the total interaction energy into components including frozen energy, polarization energy, and charge transfer energy. These energy components provide insight into the nature and strength of the ruthenium-nitrogen interaction for each candidate monomer.

The method may include determining which ring in the plurality of nitrogen containing rings is less likely to associate with the ruthenium(II) alkylidene catalyst. Monomers with weaker ruthenium-nitrogen interactions may be preferred because strong coordination of nitrogen to the ruthenium center may inhibit catalyst activity or alter polymerization selectivity. The ruthenium-nitrogen interaction screen 706 ranks candidate monomers based on interaction strength, with monomers exhibiting weaker interactions passing through to subsequent screening stages.

The bio-linker screen 708 evaluates candidate linker molecules that may be used to connect cycloolefin amine monomers or to introduce additional functionality into the polymer network. Bio-based linker molecules may be derived from renewable feedstocks and may provide crosslinking capability or other structural features in the resulting thermoset materials. The sequential application of the bio-monomer screen 702, the ring strain screen 704, the ruthenium-nitrogen interaction screen 706, and the bio-linker screen 708 progressively narrows the pool of candidate monomers to identify those most suitable for use with the ruthenium catalyst 514 in ring-opening metathesis polymerization applications.

Referring to FIG. 8, computational analysis of ruthenium-nitrogen interactions and bio-based linker molecules is illustrated. Panel (a) shows a three-dimensional molecular structure representation of a ruthenium complex interacting with a nitrogen-containing fragment, where Fragment 1 comprises a bipyridine-type ligand system containing carbon atoms, hydrogen atoms, and nitrogen atoms, and Fragment 2 comprises a ruthenium center coordinated with chlorine atoms. The interaction between the fragments is indicated by wavy lines connecting the ruthenium to a variable R group.

Panel (b) presents a bar chart displaying interaction energy values in kilojoules per mole for various R group substituents. The energy contributions are decomposed into total energy, frozen energy, polarization energy, and charge transfer energy components. The R groups range from simple hydrogen and methyl substituents to more complex amine and amide functionalities. This energy decomposition analysis enables evaluation of how different nitrogen-containing functional groups interact with the ruthenium center, where weaker total interaction energies may indicate monomers less likely to inhibit catalyst activity.

Panel (c) illustrates chemical structures of bio-based dicarboxylic acid linker molecules including succinate, glutarate, adipate, a general C5-C15 dicarboxylic acid structure, 2-methyl-adipate, trans, trans-muconic acid, and cis, cis-muconic acid. Each structure shows carboxylic acid functional groups at terminal positions, which may serve as reactive sites for incorporation into polymer networks.

Panel (d) depicts a biosynthetic pathway scheme for producing adipic acid using polyketide synthase modules. The pathway shows progression from a SNAC-activated starter unit through enzymatic domains including KS, AT, DH, ER, KR, ACP, and TE derived from BorM1, BorM2, SpnM2, and EryM6 modules, with intermediate thioester-bound structures leading to the final adipic acid product. This biosynthetic route may enable production of bio-based linker molecules from renewable feedstocks for incorporation into cycloolefin resin systems.

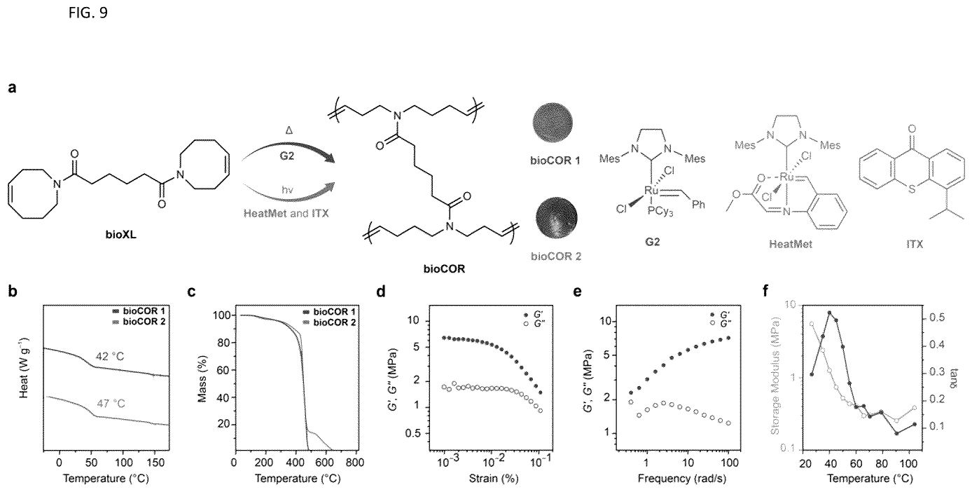

Referring to FIG. 9, synthesis and characterization of bio-based crosslinked polymers (bioCOR) from a bio-based crosslinker (bioXL) is illustrated. Panel (a) shows the bioXL monomer structure containing two cyclic amide groups connected by a central alkyl chain with pendant olefin groups. The bioXL monomer undergoes ring-opening metathesis polymerization via two pathways: a thermal pathway using a second-generation Grubbs catalyst (G2) and a photochemical pathway using HeatMet catalyst with isopropylthioxanthone (ITX) photoinitiator. Panels (b) through (f) display thermomechanical characterizations of the resulting bioCOR materials.

The thermal polymerization pathway may employ a second-generation Grubbs catalyst (G2) to initiate ring-opening metathesis polymerization of the bioXL monomer. The G2 catalyst structure includes a ruthenium center coordinated with two mesityl-substituted N-heterocyclic carbene ligands, two chloride ligands, and a benzylidene group bearing a phenyl substituent and a tricyclohexylphosphine ligand. Upon heating, the G2 catalyst activates and initiates polymerization of the cyclic olefin groups present in the bioXL monomer, forming a crosslinked bioCOR network.

The photochemical polymerization pathway may employ the HeatMet catalyst in combination with isopropylthioxanthone (ITX) as a photoinitiator. The HeatMet catalyst structure includes a ruthenium center with an N-heterocyclic carbene ligand and an ester-functionalized imine chelate. The ITX structure includes a thioxanthone core with an isopropyl substituent. Upon exposure to light, the ITX photoinitiator absorbs photons and transfers energy to activate the HeatMet catalyst, which then initiates ring-opening metathesis polymerization of the bioXL monomer. This photochemical pathway may be compatible with computed axial lithography printing applications where light-activated curing is employed.

The resulting bioCOR polymer network may be characterized using differential scanning calorimetry (DSC) to determine glass transition temperatures. As shown in panel (b) of FIG. 9, DSC curves for bioCOR 1 and bioCOR 2 indicate glass transition temperatures of 47° C. and 42° C., respectively. The glass transition temperature represents the temperature at which the polymer transitions from a glassy state to a rubbery state, and the values obtained for the bioCOR materials indicate that these polymers may exhibit solid behavior at room temperature while becoming more flexible at moderately elevated temperatures.

Thermogravimetric analysis (TGA) may be performed to evaluate the thermal stability of the bioCOR materials. As shown in panel (c) of FIG. 9, TGA curves demonstrate thermal degradation behavior of both bioCOR samples, with decomposition occurring between approximately 200° C. and 600° C. The TGA data indicate that the bioCOR materials may maintain thermal stability up to temperatures approaching 200° C. before substantial mass loss occurs due to thermal decomposition of the polymer network.

Rheological characterization of the bioCOR materials may include strain sweep, frequency sweep, and temperature sweep measurements. As shown in panel (d) of FIG. 9, a strain sweep plot displays storage modulus (G′) and loss modulus (G″) versus strain percentage, with G′ values around 5-6 MPa and G″ values around 1 MPa at low strain. The storage modulus being greater than the loss modulus indicates that the bioCOR materials exhibit predominantly elastic behavior characteristic of crosslinked polymer networks.

As shown in panel (e) of FIG. 9, a frequency sweep plot displays G′ and G″ versus frequency in radians per second, showing frequency-dependent viscoelastic behavior of the bioCOR materials. The frequency sweep data provide information about the relaxation behavior of the polymer network across different timescales.

As shown in panel (f) of FIG. 9, a temperature sweep displays storage modulus and tan delta versus temperature. The storage modulus peaks around 60-70° C. before decreasing at higher temperatures, while tan delta shows an inverse relationship. The temperature sweep data illustrate how the mechanical properties of the bioCOR materials change with temperature, with the decrease in storage modulus at elevated temperatures corresponding to softening of the polymer network as the glass transition region is traversed.

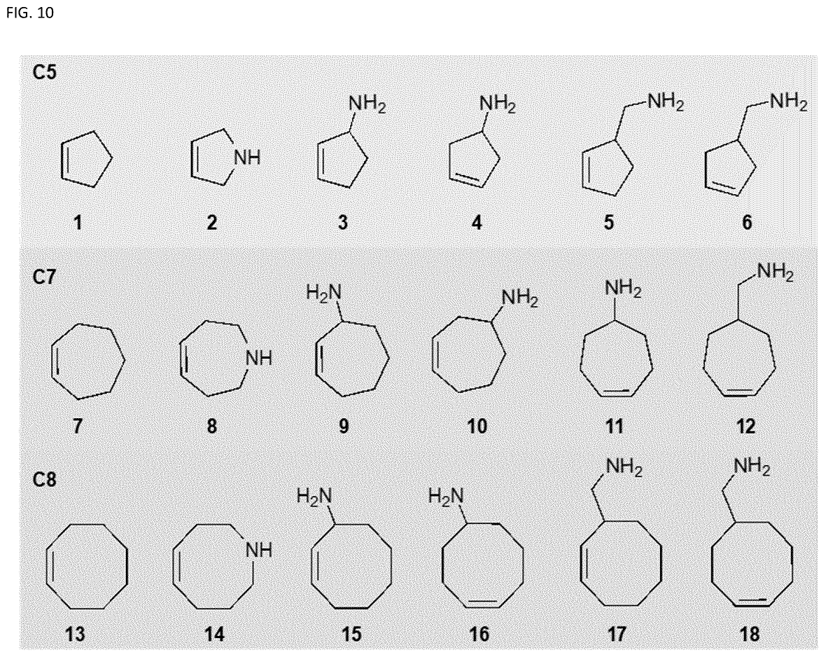

Referring to FIG. 10, a screening of cycloolefin amine structures organized by ring size is illustrated. The diagram is divided into three horizontal rows corresponding to five-membered rings (C5), seven-membered rings (C7), and eight-membered rings (C8), with each row displaying six structures for evaluation of ring strain and catalyst interaction properties.

The C5 row displays structures numbered 1 through 6. Structure 1 is cyclopentene, which serves as a reference compound for ring strain energy comparisons. Structure 2 is a nitrogen-containing five-membered ring, specifically a pyrrolidine derivative. Structures 3 through 6 are cyclopentene derivatives bearing amino groups at various positions, including direct attachment to the ring and attachment via methylene linkers. These aminocyclopentene structures represent bio-based cycloolefin amines that may be evaluated for compatibility with ruthenium-based metathesis catalysts.

The C7 row displays structures numbered 7 through 12. Structure 7 is cycloheptene, which provides a reference for seven-membered ring strain energies. Structure 8 is a nitrogen-containing seven-membered ring, specifically an azepine derivative such as 2,3,6,7-tetrahydro-1H-azepine. Structures 9 through 12 are cycloheptene derivatives with amino substituents at different positions on the ring or attached through methylene groups. The seven-membered ring structures may exhibit different ring strain energies and catalyst interaction characteristics compared to the five-membered ring analogs.

The C8 row displays structures numbered 13 through 18. Structure 13 is cyclooctene, which serves as a reference compound for eight-membered ring systems. Structure 14 is a nitrogen-containing eight-membered ring, specifically an azocine derivative such as 1,2,3,4,7,8-hexahydroazocine. Structures 15 through 18 are cyclooctene derivatives bearing amino groups either directly attached to the ring or connected via methylene linkers.

The screening process evaluates each candidate structure based on ring strain energy and ruthenium-nitrogen interaction properties. Ring strain energies may be calculated by determining the change in enthalpy of a ring closing metathesis reaction for each structure. Structures with ring strain energies similar to cyclopentene, within a tolerance of ±0.6 kJ/mol, may be identified as candidates with compatible polymerization thermodynamics for copolymerization with DCPD. The catalyst interaction evaluation assesses how the nitrogen atom in each aminocycloolefin structure interacts with the ruthenium center of metathesis catalysts. Structures where the nitrogen atom exhibits weaker coordination to ruthenium may be preferred, as strong ruthenium-nitrogen interactions may inhibit catalyst activity during ring-opening metathesis polymerization. The systematic organization of structures by ring size enables comparison of how ring size affects both ring strain energy and nitrogen-ruthenium interaction strength across the series of bio-based cycloolefin amine candidates.

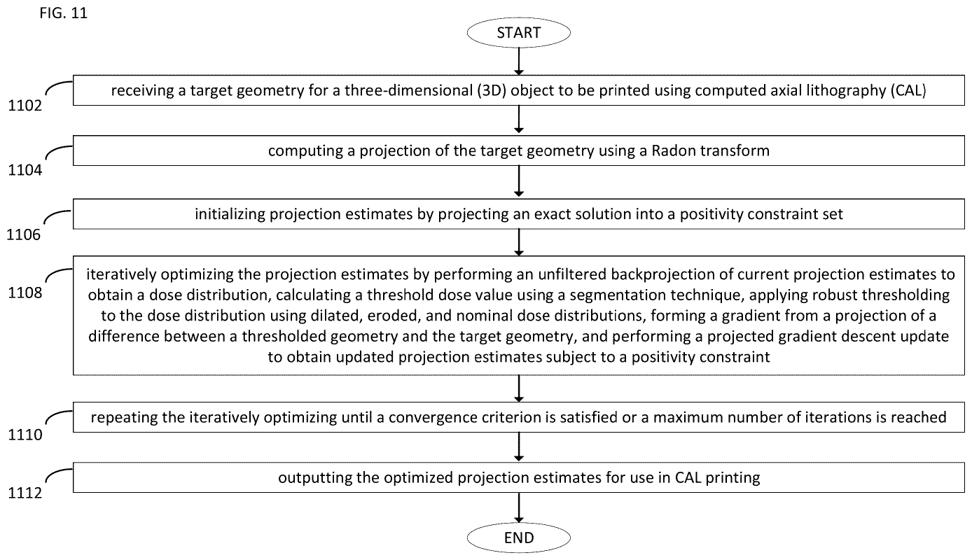

FIG. 11 illustrates a first example method embodiment. As illustrated, the method can include: receiving a target geometry for a three-dimensional (3D) object to be printed using computed axial lithography (CAL) (1102), then computing a projection of the target geometry using a Radon transform (1104). The method can then include initializing projection estimates by projecting an exact solution into a positivity constraint set (1106) and iteratively optimizing the projection estimates by performing an unfiltered backprojection of current projection estimates to obtain a dose distribution, calculating a threshold dose value using a segmentation technique, applying robust thresholding to the dose distribution using dilated, eroded, and nominal dose distributions, forming a gradient from a projection of a difference between a thresholded geometry and the target geometry, and performing a projected gradient descent update to obtain updated projection estimates subject to a positivity constraint (1108). The method then includes repeating the iteratively optimizing until a convergence criterion is satisfied or a maximum number of iterations is reached (1110) and outputting the optimized projection estimates for use in CAL printing (1112).

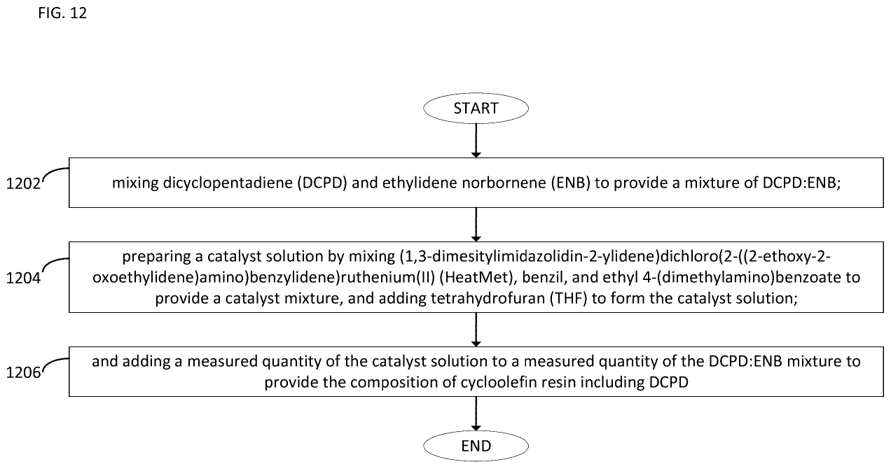

FIG. 12 illustrates a second example method embodiment. As illustrated, the method can include: mixing dicyclopentadiene (DCPD) and ethylidene norbornene (ENB) to provide a mixture of DCPD: ENB (1202), preparing a catalyst solution by mixing (1,3-dimesitylimidazolidin-2-ylidene)dichloro(2-((2-ethoxy-2-oxoethylidene)amino)benzylidene)ruthenium(II) (HeatMet), benzil, and ethyl 4-(dimethylamino)benzoate to provide a catalyst mixture, and adding tetrahydrofuran (THF) to form the catalyst solution (1204), and adding a measured quantity of the catalyst solution to a measured quantity of the DCPD: ENB mixture to provide the composition of cycloolefin resin including DCPD (1206).

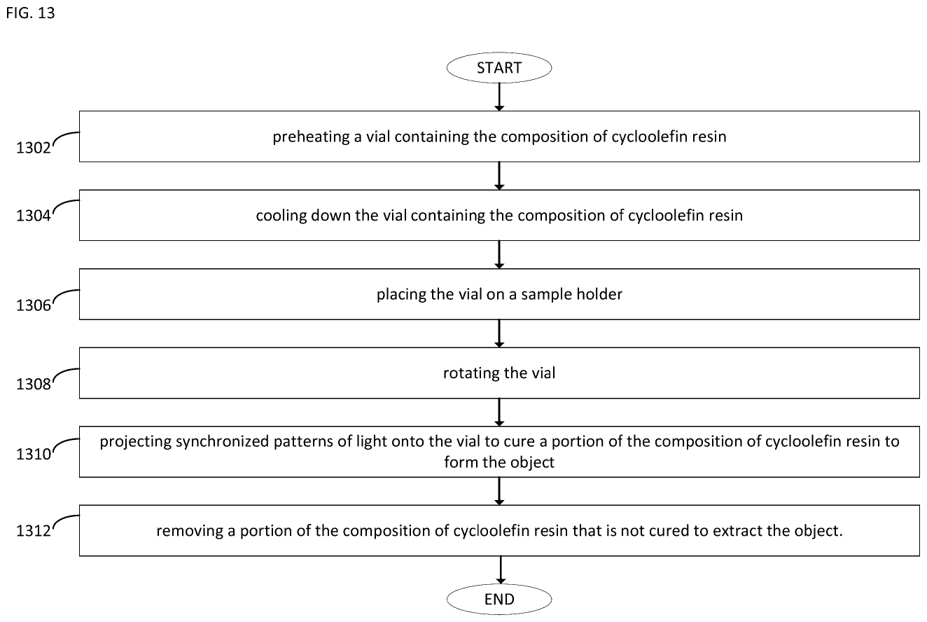

FIG. 13 illustrates a third example method embodiment. This third method uses computed axial lithography (CAL) printing to form an object using a composition of cycloolefin resin including dicyclopentadiene (DCPD), comprising a mixture of dicyclopentadiene (DCPD) and ethylidene norbornene (ENB); and a catalyst solution including (1,3-dimesitylimidazolidin-2-ylidene)dichloro(2-((2-ethoxy-2-oxoethylidene)amino)benzylidene)ruthenium(II) (HeatMet), benzil, ethyl 4-(dimethylamino)benzoate, and tetrahydrofuran (THF). As illustrated, the method can include: preheating a vial containing the composition of cycloolefin resin (1302), then cooling down the vial containing the composition of cycloolefin resin (1304) and placing the vial on a sample holder (1306). Next, the method can include rotating the vial (1308) and projecting synchronized patterns of light onto the vial to cure a portion of the composition of cycloolefin resin to form the object (1310), then removing a portion of the composition of cycloolefin resin that is not cured to extract the object (1312).

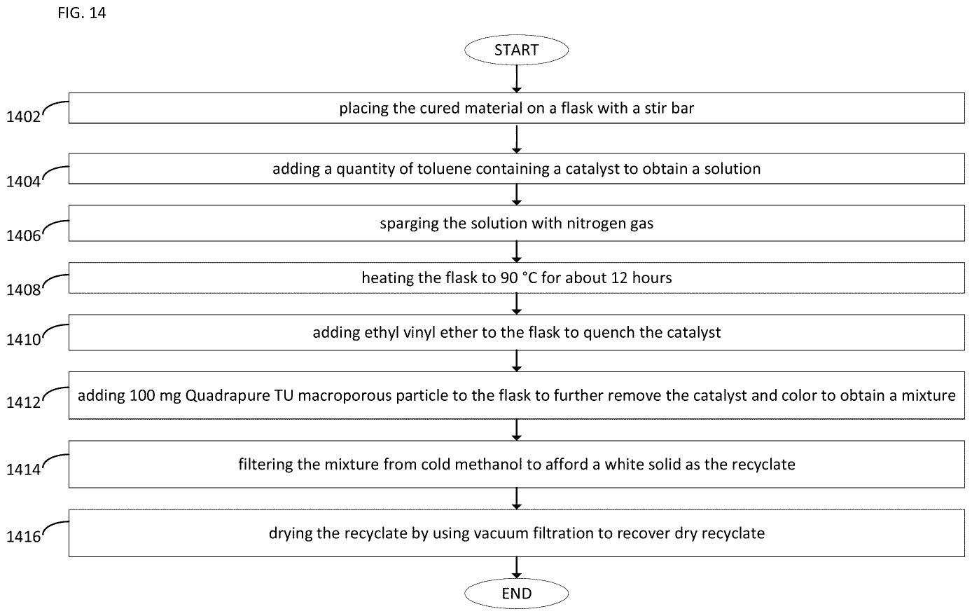

FIG. 14 illustrates a fourth example method embodiment focused on recycling a cured material including dicyclopentadiene (DCPD). As illustrated, the method can include: placing the cured material on a flask with a stir bar (1402), adding a quantity of toluene containing a catalyst to obtain a solution (1404), sparging the solution with nitrogen gas (1406), and heating the flask to 90° C. for about 12 hours (1408). Next, the method can include adding ethyl vinyl ether to the flask to quench the catalyst (1410), adding 100 mg Quadrapure TU macroporous particle to the flask to further remove the catalyst and color to obtain a mixture (1412), filtering the mixture from cold methanol to afford a white solid as the recyclate (1414), and drying the recyclate by using vacuum filtration to recover dry recyclate (1416).

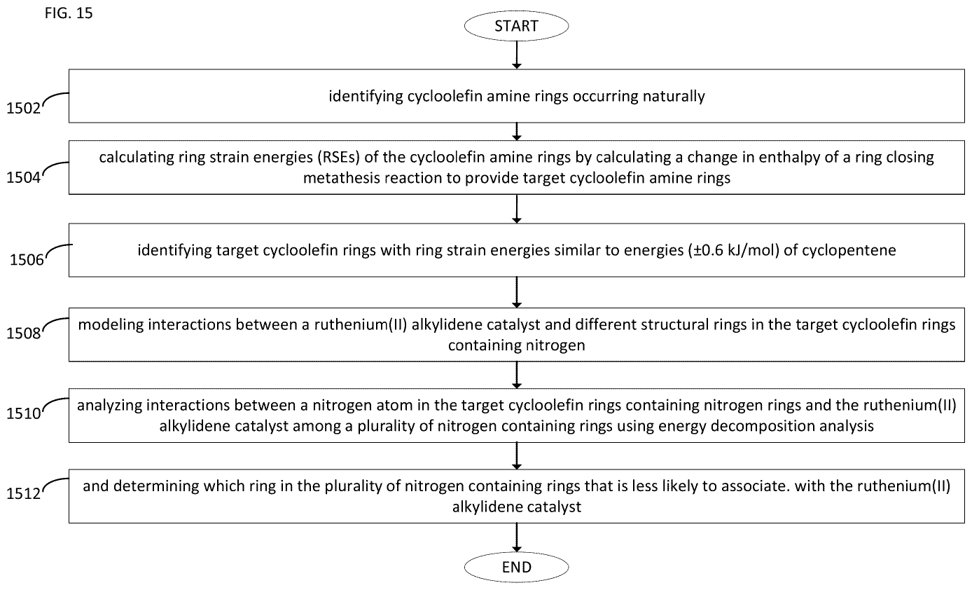

FIG. 15 illustrates a fifth example method embodiment focused on selecting a cycloolefin amine monomer from bio-based cycloolefin amines. As illustrated, the method can include: identifying cycloolefin amine rings occurring naturally (1502), calculating ring strain energies (RSEs) of the cycloolefin amine rings by calculating a change in enthalpy of a ring closing metathesis reaction to provide target cycloolefin amine rings (1504), and identifying target cycloolefin rings with ring strain energies similar to energies (±0.6 kJ/mol) of cyclopentene (1506). The method continues by modeling interactions between a ruthenium(II) alkylidene catalyst and different structural rings in the target cycloolefin rings containing nitrogen (1508), analyzing interactions between a nitrogen atom in the target cycloolefin rings containing nitrogen rings and the ruthenium(II) alkylidene catalyst among a plurality of nitrogen containing rings using energy decomposition analysis (1510), and determining which ring in the plurality of nitrogen containing rings that is less likely to associate with the ruthenium(II) alkylidene catalyst (1512).

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A composition of cycloolefin resin including dicyclopentadiene (DCPD), comprising: a mixture of dicyclopentadiene (DCPD) and ethylidene norbornene (ENB); and a catalyst solution including: (1,3-dimesitylimidazolidin-2-ylidene)dichloro(2-((2-ethoxy-2-oxoethylidene)amino)benzylidene)ruthenium(II) (HeatMet); benzil; ethyl 4-(dimethylamino)benzoate; and tetrahydrofuran (THF), wherein the composition when used in computed axial lithography (CAL) printing achieves a 1/e² transmission requirement.

The composition according to any preceding clause, wherein a quantity ratio of DCPD to ENB is about 95:5 weight percent.

The composition according to any preceding clause, wherein a quantity of HeatMet is about 10 mg or about 15.0 μmol, wherein a concentration ration of HeatMet: DCPD is 10 ppm to 40 ppm.

The composition according to any preceding clause, wherein a quantity of benzil is about 50 mg or about 237.8 μmol.

The composition according to any preceding clause, wherein a quantity of ethyl 4-(dimethylamino)benzoate is about 100 mg or about 517.5 μmol.

The composition according to any preceding clause, wherein a quantity of tetrahydrofuran (THF) is about 1 mL.

The composition according to any preceding clause, wherein a quantity of a 95:5 mixture of DCPD: ENB is about 4 mL.

The composition according to any preceding clause, wherein 65 μL of the catalyst solution is added to 4 mL DCPD: ENB, which results in a 32.5 ppm mixture of DCPD: ENB and catalyst solution.

A method of making a composition of cycloolefin resin including dicyclopentadiene (DCPD), comprising: mixing dicyclopentadiene (DCPD) and ethylidene norbornene (ENB) to provide a mixture of DCPD: ENB; preparing a catalyst solution by mixing (1,3-dimesitylimidazolidin-2-ylidene)dichloro(2-((2-ethoxy-2-oxoethylidene)amino)benzylidene)ruthenium(II) (HeatMet), benzil, and ethyl 4-(dimethylamino)benzoate to provide a catalyst mixture, and adding tetrahydrofuran (THF) to form the catalyst solution; and adding a measured quantity of the catalyst solution to a measured quantity of the DCPD: ENB mixture to provide the composition of cycloolefin resin including DCPD.

The method according to any preceding clause, wherein a quantity ratio of DCPD to ENB in the DCPD: ENB mixture is about 95:5 weight percent.

The method according to any preceding clause, wherein a quantity of HeatMet in the catalyst mixture is about 10 mg or about 15.0 μmol.

The method according to any preceding clause, wherein a quantity of benzil in the catalyst mixture is about 50 mg or about 237.8 μmol.

The method according to any preceding clause, wherein a quantity of ethyl 4-(dimethylamino)benzoate in the catalyst mixture is about 100 mg or about 517.5 μmol.

The method according to any preceding clause, wherein a quantity of THF is about 1 mL.

The method according to any preceding clause, wherein a quantity of the mixture of DCPD: ENB is about 4 mL.

The method according to any preceding clause, wherein adding a measured quantity of the catalyst solution to the measured quantity of the DCPD: ENB mixture comprises adding 65 μL of the catalyst solution to 4 mL DCPD: ENB, which results in a 32.5 ppm solution of DCPD: ENB and catalyst solution, wherein a ratio of DCPD to ENB in the DCPD: ENB mixture is about 95:5 weight percent.

The method according to any preceding clause, wherein the composition of cycloolefin resin including DCPD is provided in a vial.

The method according to any preceding clause, further comprising agitating the vial containing the composition of cycloolefin resin including DCPD.

The method according to any preceding clause, wherein a size of the vial is 15 mm ×45 mm, and an inner width or inner diameter of the vial is about 13 mm.

The method according to any preceding clause, wherein an amount of the catalyst solution in the composition of cycloolefin resin including DCPD depends on a width size or a diameter size of the vial.

The method according to any preceding clause, further comprising selecting a vial having a width or a diameter such that light penetrates through the width or diameter of the vial.

The method according to any preceding clause, wherein larger the width or diameter of the vial, longer a depth of penetration of light is needed, and a lower amount of the catalyst solution is used for a vial having a larger width or diameter, and a higher amount of the catalyst solution is used for a vial having a smaller width or diameter.

The method according to any preceding clause, wherein the width or the diameter of the vial is from 5 mm to 50 mm.

The method according to any preceding clause, wherein a transmittance of light through the width or diameter of the vial is about 13.5%, the light having a wavelength in an ultraviolet spectrum range or a visible spectrum range.

The method according to any preceding clause, wherein for a vial having an inner width or an inner diameter of about 13 mm, the catalyst solution having a concentration of 10 ppm to 40 ppm is added to the measured quantity of the DCPD: ENB mixture.

The method according to any preceding clause, wherein for a vial having an inner width or an inner diameter of about 13 mm, the catalyst solution having a concentration of 32.5 ppm is added to the measured quantity of the DCPD: ENB mixture.

A method of computed axial lithography (CAL) printing to form an object using a composition of cycloolefin resin including dicyclopentadiene (DCPD), comprising a mixture of dicyclopentadiene (DCPD) and ethylidene norbornene (ENB); and a catalyst solution including (1,3-dimesitylimidazolidin-2-ylidene)dichloro(2-((2-ethoxy-2-oxoethylidene)amino)benzylidene)ruthenium(II) (HeatMet), benzil, ethyl 4-(dimethylamino)benzoate, and tetrahydrofuran (THF), the method comprising: preheating a vial containing the composition of cycloolefin resin; cooling down the vial containing the composition of cycloolefin resin; placing the vial on a sample holder; rotating the vial; projecting synchronized patterns of light onto the vial to cure a portion of the composition of cycloolefin resin to form the object; and removing a portion of the composition of cycloolefin resin that is not cured to extract the object.

The method according to any preceding clause, wherein preheating the glass vial containing the composition of cycloolefin resin comprises preheating the glass vial at a temperature of about 70° C. for about 6 minutes.

The method according to any preceding clause, wherein cooling down the glass vial containing the composition of cycloolefin resin comprises cooling down the glass vial containing the composition of cycloolefin resin in a room temperature water bath for about one minute.

The method according to any preceding clause, further comprising transferring the object to a clean vial.

The method according to any preceding clause, further comprising washing the object with toluene to remove any remaining composition of cycloolefin resin, and drying the object inside of the vial including the object in a fume hood.

The method according to any preceding clause, further comprising post-curing at a temperature of about 120° C. in an oven inside of the fume hood for about one hour.

The method according to any preceding clause, wherein projecting synchronized patterns of light onto the vial to cure the portion of the composition of cycloolefin resin to form the object comprises projecting the synchronized patterns of light from 2 minutes to 10 minutes.

A method of recycling a cured material including dicyclopentadiene (DCPD), comprising: placing the cured material on a flask with a stir bar; adding a quantity of toluene containing a catalyst to obtain a solution; sparging the solution with nitrogen gas; heating the flask to 90° C. for about 12 hours; adding ethyl vinyl ether to the flask to quench the catalyst; adding 100 mg Quadrapure TU macroporous particle to the flask to further remove the catalyst and color to obtain a mixture; filtering the mixture from cold methanol to afford a white solid as the recyclate; and drying the recyclate by using vacuum filtration to recover dry recyclate.

The method according to any preceding clause, wherein a yield of the dry recyclate is about 84%.

The method according to any preceding clause, further comprising storing the dry recyclate under nitrogen to prevent oxidation.

The method according to any preceding clause, further comprising adding the dry recyclate up to 30% in weight to a fresh batch of DCPD: ENB without loss in material properties upon polymerization.

A method of selecting a cycloolefin amine monomer from bio-based cycloolefin amines, comprising: identifying cycloolefin amine rings occurring naturally; calculating ring strain energies (RSEs) of the cycloolefin amine rings by calculating a change in enthalpy of a ring closing metathesis reaction to provide target cycloolefin amine rings; identifying target cycloolefin rings with ring strain energies similar to energies (±0.6 kJ/mol) of cyclopentene; modeling interactions between a ruthenium(II) alkylidene catalyst and different structural rings in the target cycloolefin rings containing nitrogen; analyzing interactions between a nitrogen atom in the target cycloolefin rings containing nitrogen rings and the ruthenium(II) alkylidene catalyst among a plurality of nitrogen containing rings using energy decomposition analysis; and determining which ring in the plurality of nitrogen containing rings that is less likely to associate with the ruthenium(II) alkylidene catalyst.

The method according to any preceding clause, wherein identifying target cycloolefin rings with ring strain energies similar to energies (±0.6 kJ/mol) of cyclopentene comprises identifying 2,3,6,7-tetrahydro-1H-azepine and 1,2,3,4,7,8-hexahydroazocine as a candidate ring.

The method according to any preceding clause, wherein calculating ring strain energies (RSEs) of the cycloolefin amine rings comprises calculating a change in enthalpy of a ring closing metathesis reaction to provide target cycloolefin amine rings.

The method according to any preceding clause, wherein calculating ring strain energies (RSEs) of the cycloolefin amine rings comprises sampling conformers to find a lowest energy conformer using a conformer-rotamer ensemble sampling tool (CREST) algorithm, and calculating thermodynamic properties using density functional theory (DFT).

The method according to any preceding clause, wherein calculating the thermodynamic properties comprises calculating the thermodynamic properties in different solvent environments to simulate ring opening in polymerization and ring closing in depolymerization.

The method according to any preceding clause, further comprising ranking the target cycloolefin rings by which have favorable polymerization and depolymerization energies.

We claim:

1. A composition of cycloolefin resin including dicyclopentadiene (DCPD), comprising:
a mixture of dicyclopentadiene (DCPD) and ethylidene norbornene (ENB); and
a catalyst solution including:
(1,3-dimesitylimidazolidin-2-ylidene)dichloro(2-((2-ethoxy-2 oxoethylidene)amino)benzylidene)ruthenium(II) (HeatMet);
benzil;
ethyl 4-(dimethylamino)benzoate; and
tetrahydrofuran (THF),
wherein the composition when used in computed axial lithography (CAL) printing achieves a 1/e2 transmission requirement.

2. The composition of claim 1, wherein a quantity ratio of DCPD to ENB is about 95:5 weight percent.

3. The composition of claim 1, wherein a quantity of HeatMet is about 10 mg or about 15.0 μmol, wherein a concentration ratio of HeatMet: DCPD is 10 ppm to 40 ppm.

4. A method of making a composition of cycloolefin resin including dicyclopentadiene (DCPD), comprising:
mixing dicyclopentadiene (DCPD) and ethylidene norbornene (ENB) to provide a mixture of DCPD: ENB;
preparing a catalyst solution by mixing (1,3-dimesitylimidazolidin-2-ylidene)dichloro(2-((2-ethoxy-2-oxoethylidene)amino)benzylidene)ruthenium(II) (HeatMet), benzil, and ethyl 4-(dimethylamino)benzoate to provide a catalyst mixture, and adding tetrahydrofuran (THF) to form the catalyst solution; and
adding a measured quantity of the catalyst solution to a measured quantity of the DCPD:ENB mixture to provide the composition of cycloolefin resin including DCPD.

5. The method of claim 4, wherein a quantity ratio of DCPD to ENB in the DCPD:ENB mixture is about 95:5 weight percent.

6. The method of claim 4, wherein the composition of cycloolefin resin including DCPD is provided in a vial.

7. The method of claim 6, wherein an amount of the catalyst solution in the composition of cycloolefin resin including DCPD depends on a width size or a diameter size of the vial.

8. The method of claim 6, further comprising selecting a vial having a width or a diameter such that light penetrates through the width or diameter of the vial.

9. The method of claim 8, wherein larger the width or diameter of the vial, longer a depth of penetration of light is needed, and a lower amount of the catalyst solution is used for a vial having a larger width or diameter, and a higher amount of the catalyst solution is used for a vial having a smaller width or diameter.

10. The method of claim 9, wherein the width or the diameter of the vial is from 5 mm to 50 mm.

11. The method of claim 9, wherein a transmittance of light through the width or diameter of the vial is about 13.5%, the light having a wavelength in an ultraviolet spectrum range or a visible spectrum range.

12. A method of recycling a cured material including dicyclopentadiene (DCPD), comprising:
placing the cured material on a flask with a stir bar;
adding a quantity of toluene containing a catalyst to obtain a solution;
sparging the solution with nitrogen gas;
heating the flask to 90° C. for about 12 hours;
adding ethyl vinyl ether to the flask to quench the catalyst;
adding 100 mg Quadrapure TU macroporous particle to the flask to further remove the catalyst and color to obtain a mixture;
filtering the mixture from cold methanol to afford a white solid as the recyclate; and
drying the recyclate by using vacuum filtration to recover dry recyclate.

13. The method of claim 12, wherein a yield of the dry recyclate is about 84%.

14. The method of claim 12, further comprising storing the dry recyclate under nitrogen to prevent oxidation.

15. The method of claim 12, further comprising adding the dry recyclate up to 30% in weight to a fresh batch of DCPD: ENB without loss in material properties upon polymerization.

16. The method of claim 12, wherein the catalyst comprises a second generation Hoveyda-Grubbs ruthenium(II) alkylidene catalyst.

17. The method of claim 12, wherein the cured material comprises a copolymer of DCPD and ethylidene norbornene (ENB).

18. The method of claim 12, wherein the cured material comprises a copolymer of DCPD and cyclooctene (COE).

19. The method of claim 12, wherein a concentration of the cured material in the toluene is about 50 mM.

20. The method of claim 12, wherein the catalyst is present at about 0.2 mol %.
